(19) United States
(12) Patent Application Publication
(10) Pub. No.: US 2004/0221297 A1
(43) Pub. Date: Nov. 4, 2004

(54) Event-related screensaver

(75) Inventors: Michael Greve, Karlsruhe (DE); Pierre-Alain Cotte, Amberg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: WEB.DE AG, Karlsruhe (DE)

(21) Appl. No.: 10/426,607

(22) Filed: Apr. 30, 2003

(51) Int. Cl. G06F 9/00

(52) U.S. Cl. 719/318

(57) ABSTRACT

A method for operating an end user unit includes operating a screensaver on the end user unit and embedding event-related data into an output of the screensaver so as to maintain an operation of the screensaver.

In general, the present invention relates to the operation of an end user unit that employs a screensaver. Particularly, the present invention is concerned with an event-related operation of an end user unit with respect to a screensaver executed thereon. More particularly, the present invention is directed to an operation of a screensaver wherein event-related data are embedded into an output thereof such that a user can be informed of the event without interrupting an operation of the screensaver.

### BACKGROUND

In general, the term “screensaver” indicates a software program that generates, upon its activation, an animated image on the monitor of a computer when no user activity has been sensed for a certain time. The original purpose of a screensaver is to prevent a so-called “bum-in”, i.e., the burning of an image into the phosphor inside the cathode ray tube after hours of the same image being rescanned.

In response to any user activity, for example, manipulating a mouse or using a keyboard of the computer, the screensaver is terminated such that the animated image is no longer displayed and the computer monitor provides its normal functions.

As long as a screensaver is operated, a user is provided only the visual “information” of the screensaver, which is, to be correct, no actual information, i.e., information of any content of interest for the user. If the user uses the computer again, the screensaver is de-activated and information of interest can be displayed again. Thus, information related to user activities (e.g., inputting of text via the keyboard) as well as related to hardware and software operations and conditions (e.g., signaling from a computer component such as a floppy disc or CD drive, data generated by a software program) can by displayed for the user on the monitor.

When the screensaver is in operation, and consequently its visual output is displayed on the computer monitor, any information indicating an occurrence related to the computer but not resulting from a user activity is not displayed. For example, the receipt of a new e-mail will not be noticed by the user as long as the screensaver is still running. Only when the screensaver is de-activated in response to a user activity can the user be informed of the new e-mail, for example, via a respective display of an e-mail program.

As a result, the user will became aware of such occurrences only if a user activity has resulted in the termination of the screensaver. Thus, it is possible that occurrences related to the computer but not to any user activity might be missed or not promptly noticed.

Moreover, the procedure to obtain information of such computer-related occurrences triggers the screensaver to be inactivated. This can pose a further problem because usually a screensaver only will be activated after a certain period of time for which no user activity in relation to the computer has been detected. As a result, if, for example, the user checks the computer for such occurrences by terminating the screensaver operation and detects that an occurrence is of minor or no interest or that just little information relating to an occurrence is provided, the computer monitor will not be protected by the screensaver for that certain period of time. Depending on the setup of the screensaver, in particular the period of time to be passed for activation thereof, and the quality of the computer monitor, this can cause damages of the computer monitor or, at least, a reduced operation life.

In addition, screensavers are often associated with functions to save power consumption of computer systems. For that purpose, for example, upon an activation of a screensaver, the power consumption of computer monitor can be reduced by decreasing its brightness, scan frequency and image refresh rate. Also, in response to a start of a screensaver, it is possible to de-activate hardware and software components of a computer system in order to reduce power consumption during a time of no user activity. For example, an operation of a screensaver can be combined with the termination of software programs and a power saving operation of hardware devices such as a hard disk drive.

Usually, such power saving measures are maintained as long as the screensaver is in operation. As soon as a user activity is detected and the screensaver is inactivated in response thereto, power saving measures related to the operation of the screensaver are terminated. In consequence, user activity to check for occurrences not related to user activity would not only inactivate the screensaver but also any associated power saving measure. In case, an occurrence is of minor or no interest or just little information relating to an occurrence is provided, the computer system will not to benefit from power saving measures associated with the screensaver as long as the screensaver is not restarted.

### SUMMARY OF THE INVENTION

In general, an object of the present invention is to overcome the above problems related to screensavers. In particular, it is an object of the present invention to provide a screensaver that allows a device user, e.g., a computer user, to be informed of situations or occurrences which may change the state of the device or may be of interest to the user but are not related to a user activity with respect to that device, wherein the benefits of a traditional screensaver can still be provided. Such occurrences or situations will herein be referred to as “events.”

The present invention provides a method of operating an end user unit. The method includes: operating a screensaver on the end user unit; and embedding event-related data into an output of the screensaver so as to maintain an operation of the screensaver.

The operation of the screensaver may be associated with de-activating a component of the end user unit. The component may be a hardware or software component. Where the output of the screensaver is a visual output, the event-related data may be embedded into the visual output as a visual display. Where the output of the screensaver is an acoustic output, the event-related data may be embedded into the acoustic output as an acoustic display.

An event may include any of the following occurrences: data occurring within the end user unit, data communicated to the end user unit, signaling received by the end user unit, an event detected within a communications environment associated with the end user unit, an event identified by a telecommunications web site as an incoming event, an event identified by a telecommunications web site as an internal event, an event initiated by a telecommunications web site as an outgoing event, and an event characterizing results of a caller recognition.

The present invention also provides an event-related screensaver including a data reception element and a processor. The data reception element is configured to receive data related to an event. The processor is configured to present an output on the end user unit and embed data related to the event into the output.

A web site is also provided by the present invention. The web site includes an event identification element and a processor. The event identification element is configured to identify an event. The processor is configured to generate data related to the event and to provide the data to an end user unit.

The present invention also provides a communications environment including a web site and an end user unit. The web site is configured to identify and generate data related to an event and to provide the data to an end user unit. The end user unit has a screensaver operating thereon, and the end user unit is configured to embed the data related to the event into an output of the screensaver so as to maintain an operation of the screensaver.

Also provided by the present invention is a computer readable medium having stored thereon computer executable process steps operative to perform a method for operating an end user unit. The method includes: operating a screensaver on the end user unit; and embedding event-related data into an output of the screensaver so as to maintain an operation of the screensaver.

In contrast to the above-discussed prior screensavers, which are limited to computer systems, the present invention contemplates “screensavers” for any of a variety of types of end user units that include any of a variety of types of output, such as visual and acoustic outputs. Thus, the screensaver of the present invention may encompass functions related to visual, acoustic or other types of outputs.

### BRIEF DESCRIPTION OF THE DRAWINGS

In the following the present invention will be elaborated upon based on exemplary embodiments with reference to the drawings, in which:

FIG. 1 shows a schematic diagram of a communications environment according to an embodiment of the present invention; and

FIG. 2 shows a schematic flow diagram of a method for operating an end user unit according to an embodiment of the present invention.

### DETAILED DESCRIPTION

An end user unit as used herein is a device, unit or means, which can be used for communications. An end user unit may include any of stationary and mobile telephones (e.g., PSTN telephones, 2G and 3G devices, GSM and UMTS telephones), stationary and mobile computer systems, devices and units, telex systems, devices and units, etc.

The end user unit of the present invention is not limited to a particular communications unit/device or any communications network. Rather, communications by means of an end user unit can occur via any communications network such as regular telephone networks, mobile communications networks, computer networks, radio transmission networks, the Internet, etc., Further, an end user unit is not restricted to single devices or means, but can also include two and more units, devices, means and the like providing data/information sending and/or receiving capabilities for communications purposes, e.g., an ordinary letter and a scanner.

The end user unit can be adapted to perform network-based communications. Thus, the end user unit is connectable to a network or rather able to communicate with a network. A network in this context is a physical transport medium in which data and/or signals can be fed. For example, an ordinary letter itself is adapted to perform network-based communication when scanned or digitized and supplied into a TCP/IP network.

Comparable to a computer, an end user unit in terms of the present invention is also prone to faults and damages occurring during periods of time where the end user unit is activated (“power on”) but not actually used. For example, in case of an end user unit embodied as mobile communications device (“mobile telephone”), during periods of time where no communications are performed, is possible to employ measures for providing functions for such an end user unit comparable to functions provided by a conventional screensaver in relation to a computer. In the following, the term “screensaver” will be used to indicate any kind of hardware and/or software means or measure which provides, for a visual display device of an end user unit, a screensaver function.

In an embodiment of the present invention, the event-related data are embedded in the output of the screensaver such that at least some of the hardware and/or software components of the end user unit which are de-activated in association the operation of the screensaver are not activated in response to the embedding of the event-related data. In case of a screensaver of a computer, this allows to maintain power saving measures taken in with respect to, for example, a hard disk drive and peripherals as well as software programs not actually required to be operated as long as the screensaver is active.

Further, in an embodiment of the present invention, for carrying out the method according to the present invention, an environment is defined or selected for which events are to be considered. In case the end user unit is associated with a communications environment, it is contemplated to monitor the communications environment to detect an event for which data are to be embedded as event-related data. In an embodiment of the present invention, a communications environment is a communications system comprising more than one component, i.e., more than one device and/or type of device, media and/or type of media, network and/or type of network. Thus, a communications environment or communications system might, for instance, comprise a mobile telephone network (e.g., GSM or UTMS network), a PSTN-network, a data network (e.g., the Internet or an intranet), etc.,

In an embodiment of the present invention, the event-related data are related to an event associated with a telecommunications web site, which can be associated with the end user unit or to a computer system, a network service provider, a different end user unit, etc.

The terms “web site” and “web page” define sites and sub-sites associated thereto which can be uniquely addressed by means of a single address, like a telephone number or an IP address, a uniform resource locator (URL), etc., A web site may be used in a 3G-communication environment, especially an UMTS environment. A web site may be a site on the Internet with a specific URL, such as a site on the World Wide Web, which can be accessed by Internet visitors, and by the web site host. The web site host is the owner of the web site.

A web site can include one or more web pages. These web pages are part of the one web site. It should be noted that the terms “web site” and “web page” are not to be considered to limit the present invention to conventional Internet web sites and web pages. Thus, the web site and its web page(s), respectively, can be accessed by establishing a communications link from the first end user unit independently of the network(s) employed.

In particular a telecommunications web site is adapted to provide, upon an access by an end user unit, for direct private communications between the accessing end user unit and an end user unit to which a communications link is to be established.

A telecommunications web site is preferably a web site adapted to provide, upon an access event, for private communications between two entities. Preferably, the telecommunications web site corresponds to a first specific entity and is adapted to provide, upon an access by the first end user unit, for private communications between the first end user unit and the first specific entity. The terms “telecommunications web site”, “web site” and “web page” may be understood to encompass software and hardware components effecting these entities. Such components may include one or more processors, for example.

A telecommunications web site is assigned to or personalized for or corresponding to a specific person or entity. Such a specific entity can be a person, a company or any other entity. The specific entity preferably acts as the host of the telecommunication web site. The specific entity may be a single entity, e.g., a specific user or owner (e.g., a single person, a company, a unit of a company, etc.) of the telecommunications web site, a specific address, a specific location, a specific end user unit and the like. Thus, an end user unit of a user associated with a telecommunications web will be also associated with that telecommunications web site if used by the user for accessing the telecommunications web site. Therefore, the specific entity associated with a telecommunications web site and an end user unit employed by the specific entity can be considered, for certain purposes, synonymous for the period of time the specific entity operates its end user unit to access its telecommunications web site.

Properties and functions of a telecommunications web site, including its core engine, are described in commonly-assigned U.S. patent application Ser. No. 10/201446, entitled “Communications Environment,” filed Jul. 23, 2002, and in commonly-assigned U.S. patent application Ser. No. 10/354709, entitled “Web Site Having an Event Identification Element,” filed Jan. 29, 2003, both of which applications are hereby incorporated by reference herein.

An advantage of a telecommunications web site is that communications can be provided and established in a multi-protocol fashion, i.e., a communications connection may include different types of communications links, such as links of PSTN-networks, UMTS-networks, TCP/IP based networks, etc. For example, the connection of a telephone in a PSTN-network to a UMTS device in an UMTS-includes is a multi-protocol connection. Such a connection in parallel with a connection of a computer in a TCP/IP based network to another computer in a TCP/IP based network is also a multi-protocol connection as herein defined. Thus, the parallel use of different types of communications links is a multi-protocol connection. The individual links may carry various types of communications media (voice, data, video, etc.). These different types of communications links can be employed by using different end user units or different networks, such as, for example, PSTN, IP-based networks or UMTS networks.

In an embodiment of the present invention, the event-related data are generated in response to at least one of data occurring within the end user unit (e.g., a scheduler running on the end user unit, a software program which has finished its calculations), data communicated to the end user unit (e.g., from a peripheral device associated the end user unit), signaling received by the end user unit (e.g., from a sensor), an event detected within a communications environments the end user unit is associated to (e.g., telephone call, fax, SMS, etc., directed to the end user unit), an event identified by a telecommunications web site as incoming event (e.g., telephone call, fax, SMS, etc., directed to the telecommunications web site and/or the end user unit), an event identified by a telecommunications web site as internal event (e.g., time based events such as meetings, birthdays, etc.), an event initiated by a telecommunications web site as outgoing event (e.g., telephone call, fax, SMS, etc., initiated by the telecommunications web site and/or the end user unit) and an event characterizing results of a caller recognition (e.g., performed by the telecommunications web site and/or the end user unit in response to an incoming telephone call).

Is contemplated that the event-related data are generated depending on the associated event, for example by different data or data types for different types of events. For example, for the following events, the event-related data according to an embodiment of the present invention is indicated in parenthesis following each event:

New E-mail (subject, sender)

Telephone Call (telephone number, caller)

SMS (text, sender)

MMS (picture, sender)

IM (information, sender)

New E-mails (number of e-mail messages)

New SMSs (number of SMS messages)

Missed Telephone Calls (number of missed telephone calls)

Received Faxes (number of received faxes)

Further, it is possible to characterize an event by the event-related data. For example, it is considered to generate event-related data in such a manner that a user of the end user unit can quickly and simply recognize which type of event is indicated by the event-related data embedded into the screensaver output.

Where the output of the screensaver is a visual output, the event-related data can be embedded into the visual output as visual display or information. In particular it is contemplated to embed the event-related data as alphanumeric text, graphics, icon, virtual button, pull-down menu, virtual slidebar or window into the screensaver output. This can be accomplished by means of a graphic overlay over the visual output of the screensaver such that at least parts of the visual output remain visible, of a graphic overlay over the visual output of the screensaver such that the only the visual display (i.e., the event-related data) is visible, or of embedding the event-related data into the output of the screensaver such that the visual output is replaced by the visual display.

Where the output of the screensaver is an acoustic output, the event-related data can be embedded into the acoustic output as acoustic display. In particular it is contemplated to use an acoustic alert, a sound, a melody, an output of artificial speech, an output of pre-recorded speech and the like as the acoustic display of the event-related data. For embedding event-related data into the acoustic output of a screensaver it is possible to use an acoustic overlay over the acoustic output of the screensaver such that at least parts of the acoustic output remain audible, an acoustic overlay over the acoustic output of the screensaver such that only the acoustic display is audible, or to embed the event-related data into the output of the screensaver such that the acoustic output is replaced by the acoustic display.

In general, as used herein, “embedding” event-related data into the screensaver output refers to presenting information in the screensaver output in any form that indicates or represents the event-related data. For example, in an embodiment, where the event-related data indicate two e-mails have been received, the event-related data is embedded by displaying an envelope icon with the numeral “2” on a visual screensaver output.

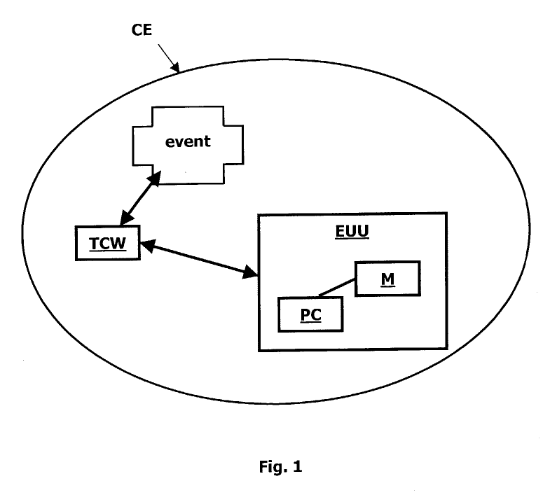

FIG. 1 shows a communications environment CE including an end user unit EUU, which includes a personal computer PC and a monitor M associated thereto. Communications environment CE may be the Internet, for example. Further, a telecommunications website TCW also employed in the communications environment CE is associated with the end user unit EUU.

The personal computer PC includes a data reception element and a processor. The processor is in an embodiment the central processor of the personal computer. The data reception element in an embodiment is a client listening on a TCP socket for new commands from the telecommunications web site TCW, acting as a server.

The telecommunications web site TCW includes an event identification element and a processor. The event identification element is capable of identifying events, as described in commonly-assigned U.S. patent application Ser. No. 10/354709, entitled “Web Site Having an Event Identification Element,” filed Jan. 29, 2003, which, as noted above, is incorporated by reference herein.

When an appropriate event occurs within the communications environment CE, the event identification element of the telecommunications web site TCW detects the event. In response to a detected event, the processor of the telecommunications web site TCW generates event-related data characterizing that event. For example, event-related data can indicate whether the event associated thereto is an e-mail directed to the user of the end user unit EUU or its personal computer PC, respectively, a telephone call directed to the user, or a fax addressed to the user.

The event-related data are communicated to the end user unit EUU and in particular to its personal computer PC. The data reception element of the personal computer PC receives the event-related data. The processor of the personal computer PC embeds the event-related data into an output of a screensaver running on the personal computer. Where the personal computer PC is not in a condition of operation in which its screensaver is activated, the event-related data can be presented to the user of the personal computer PC in conventional manner, such as by a visual display on the computer monitor M and/or acoustic display via computer PC speakers (not shown)

The event-related data may be communicated automatically by the telecommunications web site TCW (“push”) or in response to a query from the end user unit EUU (“pull”). In an embodiment of the present invention, for the “push” situation, the event identification element of the telecommunications web site TCW identifies an event. The event may be an e-mail message, SMS, fax, telephone call, MMS or IM. The processor of the telecommunications web site TCW generates data related to the event and communicates, or pushes, the data to the end user unit EUU. If there is no previously-established connection to the end user unit EUU, the telecommunications web site TCW in an embodiment first opens a client-server connection between the telecommunications web site TCW the end user unit EUU before communicating the event-related data. In the “pull situation,” the end user unit EUU communicates a query to the telecommunications web site TCW, requesting transmission of relevant event-related data from the telecommunications web site. In both the push and pull situations, the data reception element of the end user unit EUU receives the event-related data from the telecommunications web site TCW. The processor of the end user unit presents an output on the end user unit and embeds the data related to the event into the output. Embedding the event-related data in an embodiment entails selecting an image or symbol from a graphical library using a control program. The image or symbol is selected depending on the received event-related data. The selected image or symbol is then displayed them on the monitor M of the end user unit EUU.

Where the screensaver of the personal computer PC is activated, the output of the screensaver, for example an animated image, will be displayed on the computer monitor M. In response to the event-related data communicated from the telecommunications website TCW, according to the present invention the screensaver remains activated while the event-related data are embedded in its output. As a result, the user of the personal computer PC is informed about the event detected by the telecommunications website by a display of the event-related data while the personal computer PC and its monitor M remain with their respective operational conditions influenced by the screensaver. For example, power saving measures associated with the screensaver are maintained. It should be noted that in some embodiments the event-related data may be embedded in pure form, and in other embodiments in a modified form, into the screensaver output. For example, a predetermined respective symbol could be embedded to represent the reception of an e-mail, telephone call, etc.

The embedding of event-related data into the screensaver output may be effected as a function of the type of screensaver used with the personal computer PC. For example, if a screensaver used in combination with the end user unit EUU only provides for a visual output in form of a graphical display on the computer monitor M (“animated image”) the event-related data can be embedded to into of the visual screensaver output in form of a graphical overlay at least partially covering the graphical display provided by the screensaver. If the screensaver also provides acoustic output, the event-related data or parts thereof can be embedded into the acoustic output of the screensaver.

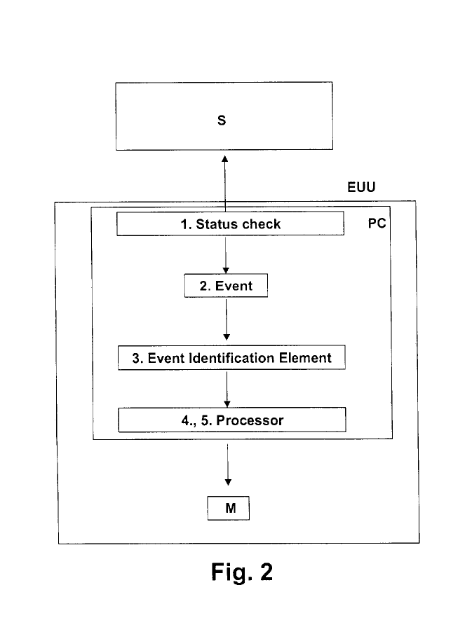

Referring now to FIG. 2, a schematic example of a method for operating an end user unit to embed event-related data into a screensaver output is presented. Here, the event-related data is received in response to a query, or status check, from the end user unit EUU, i.e., a “pull” situation. Server S may be a communications or e-mail server, such as, for example, an IMAP or POP3 server. In other embodiments of the present invention, server S is a telecommunications web site. End user unit EUU includes a personal computer PC and a monitor M associated thereto, as well as an event identification element and a processor.

### EXAMPLE

1. The end user unit EUU performs a status-check that checks the status of the server S and pulls available information (occurrences and situations) relating to events to the end user unit.

2. The event can be either an occurrence or a situation. Information about the event is transferred to the event identification element of the end user unit EUU.

3. The event identification element of the end user unit EUU identifies the event, which could be a new E-Mail, SMS, Fax, Phone Call, MMS or IM (occurrences) or a status report (situation). The event identification element is in an embodiment a software program configured to recognize and/or categorize an event from information about the event.

4. The processor of the end user unit EUU generates data related to the event.

5. The processor of the end user unit EUU presents an output on the monitor M and embeds the data related to the event into the output. The embedding is accomplished using a graphical library or control program to choose different symbols or images depending on the event-related data received from the processor of end user unit EUU, and by displaying the symbols or images on the monitor M.

In the preceding specification, the present invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What ic claimed is:

1. A method for operating an end user unit comprising:
operating a screensaver on the end user unit; and
embedding event-related data into an output of the screensaver so as to maintain an operation of the screensaver.

2. The method as recited in claim 1 wherein the operation of the screensaver is associated with de-activating a component of the end user unit.

3. The method as recited in claim 2 wherein the component is a hardware component.

4. The method as recited in claim 2 wherein the component is a software component.

5. The method as recited in claim 1 wherein the end user unit is associated with a communications environment and further comprising monitoring the communications environment so as to detect an event related to the event-related data.

6. The method as recited in claim 1 wherein the event-related data is related to an event associated with a telecommunications web site.

7. The method as recited in claim 1 wherein the event-related data include at least one of a subject and a sender of an e-mail message, a telephone number and a name of a caller, a text and a sender of an SMS message, a graphic and a sender of an MMS message, information and a sender of an IM message, a number of e-mails, a number of SMS messages, a number of missed telephone calls, a number of received faxes, and a symbol representing a communication.

8. The method as recited in claim 1 further comprising generating the event-related data in response to at least one of data occurring within the end user unit, data communicated to the end user unit, signaling received by the end user unit, an event detected within a communications environment associated with the end user unit, an event identified by a telecommunications web site as an incoming event, an event identified by a telecommunications web site as an internal event, an event initiated by a telecommunications web site as an outgoing event, and an event characterizing results of a caller recognition.

9. The method as recited in claim 1 further comprising generating the event-related data based on an associated event.

10. The method as recited in claim 1 wherein the event-related data characterize an associated event.

11. The method as recited in claim 1 wherein the output of the screensaver is a visual output and wherein the embedding is performed so as to embed the event-related data into the visual output as a visual display.

12. The method as recited in claim 11 wherein the visual display includes at least one of alphanumeric text, graphics, an icon, a virtual button, a pull-down menu, a virtual slide bar and a window.

13. The method as recited in claim 11 wherein the visual display is embedded as graphic overlay in the visual output so that at least part of the visual output remains visible.

14. The method as recited in claim 11 wherein the visual display is embedded as graphic overlay in the visual output so as to replace the visual output.

15. The method as recited in claim 1 wherein the output of the screensaver is an acoustic output and wherein the embedding is performed so as to embed the event-related data into the acoustic output as an acoustic display.

16. The method as recited in claim 15 wherein the acoustic display comprises at least one of an acoustic alert, a sound, a melody, an output of artificial speech and an output of pre-recorded speech.

17. The method as recited in claim 15 wherein the acoustic display is embedded as acoustic overlay in the acoustic output so that at least part of the acoustic output remains audible.

18. The method as recited in claim 15 wherein the acoustic display is embedded as acoustic overlay in the acoustic output so as to replace the acoustic output.

19. The method as recited in claim 1 further comprising receiving the event-related data from a telecommunications web site.

20. The method as recited in claim 1 further comprising receiving the event-related data from a communications or e-mail server.

21. An event-related screensaver comprising:
a data reception element configured to receive data related to an event; and
a processor configured to present an output on an end user unit and embed data related to the event into the output.

22. The event-related screensaver as recited in claim 21 wherein the processor is configured to deactivate a hardware component of the end user unit.

23. The event-related screensaver as recited in claim 22 wherein the processor is configured to deactivate a software component of the end user unit.

24. The event-related screensaver as recited in claim 21 wherein event is associated with a telecommunications web site.

25. The event-related screensaver as recited in claim 21 wherein the event includes as least one of data occurring within the end user unit, data communicated to the end user unit, signaling received by the end user unit, an event detected within a communications environment associated with the end user unit, an event identified by a telecommunications web site as an incoming event, an event identified by a telecommunications web site as an internal event, an event initiated by a telecommunications web site as an outgoing event, and an event characterizing results of a caller recognition.

26. The event-related screensaver as recited in claim 21 wherein the output is a visual output and wherein the processor is configure to embed the data related to the event into the visual output as a visual display.

27. The event-related screensaver as recited in claim 21 wherein the output is an acoustic output and wherein the processor is configure to embed the data related to the event into the acoustic output as an acoustic display.

28. A web site comprising:
an event identification element configured to identify an event; and
a processor configured to generate data related to the event and to provide the data to an end user unit.

29. The web site as recited in claim 28 wherein the processor is configured to provide, upon an access of the web site by the end user unit, private communications between the end user unit and a second end user unit.

30. The web site as recited in claim 28 wherein the event includes as least one of data occurring within the end user unit, data communicated to the end user unit, signaling received by the end user unit, an event detected within a communications environment associated with the end user unit, an event identified by a telecommunications web site as an incoming event, an event identified by a telecommunications web site as an internal event, an event initiated by a telecommunications web site as an outgoing event, and an event characterizing results of a caller recognition.

31. A communications environment comprising:
a web site configured to identify generate data related to an event and to provide the data to an end user unit; and
an end user unit having a screensaver operating thereon, the end user unit being configured to embed the data related to the event into an output of the screensaver so as to maintain an operation of the screensaver.

32. The communications environment as recited in claim 31 wherein the operation of the screensaver is associated with de-activating a component of the end user unit.

33. The communications environment as recited in claim 32 wherein the component is a hardware component.

34. The communications environment as recited in claim 32 wherein the component is a software component.

35. The communications environment as recited in claim 31 wherein the output of the screensaver is a visual output and wherein the end user unit is configured to embed the data related to the event into the visual output as a visual display.

36. The communications environment as recited in claim 31 wherein the output of the screensaver is an acoustic output and wherein the end user unit is configured to embed the data related to the event into the acoustic output as an acoustic display.

37. A computer readable medium having stored thereon computer executable process steps operative to perform a method for operating an end user unit, the method comprising:
operating a screensaver on the end user unit; and
embedding event-related data into an output of the screensaver so as to maintain an operation of the screensaver.

38. The computer readable medium as recited in claim 37 wherein the operation of the screensaver is associated with de-activating a component of the end user unit.

39. The computer readable medium as recited in claim 37 wherein the method further comprising generating the event-related data in response to at least one of data occurring within the end user unit, data communicated to the end user unit, signaling received by the end user unit, an event detected within a communications environment associated with the end user unit, an event identified by a telecommunications web site as an incoming event, an event identified by a telecommunications web site as an internal event, an event initiated by a telecommunications web site as an outgoing event, and an event characterizing results of a caller recognition.

40. The computer readable medium as recited in claim 37 wherein the output of the screensaver is a visual output and wherein the embedding is performed so as to embed the event-related data into the visual output as a visual display.
